(19) United States
(12) Patent Application Publication
(10) Pub. No.: US 2015/0294079 A1
(43) Pub. Date: Oct. 15, 2015

(54) TELEHEALTH SYSTEM AND PROCESS

(71) Applicant: Pierre R. Bergougnan, Newport Coast, CA (US)

(72) Inventor: Pierre R. Bergougnan, Newport Coast, CA (US)

(21) Appl. No.: 14/683,816

(22) Filed: Apr. 10, 2015

Related U.S. Application Data
(60) Provisional application No. 61/978,663, filed on Apr. 11, 2014.

(51) Int. Cl. G06F 19/00; G06Q 50/22

(52) U.S. Cl. CPC G06F 19/3418; G06Q 50/22; G06F 19/3456

(57) ABSTRACT

A telehealth system and process including a telehealth cart having one or more processors configured to execute computer-executable instructions; a video interface; an audio interface; a vital sign unit; and one or more medical devices connected to the vital sign unit; a patient located proximate to the telehealth cart; a nurse located proximate to the telehealth cart and the patient; a remote physician at a location distal from the patient and the nurse; where the remote physician establishes a secure connection to the telehealth cart and interacts with the patient via the video interface and the audio interface of the telehealth cart; and where the nurse uses at least one of the one or more medical devices on the patient at the direction of the remote physician.

### CROSS-REFERENCE TO RELATED APPLICATIONS

This applications claims priority to and the benefit of U.S. Provisional Application No. 61/978,663, filed Apr. 11, 2014, the disclosure of which is incorporated by reference herein for all purposes.

### TECHNICAL FIELD

The invention, in its several embodiments, pertains to medical treatment, and more particularly to telemedicine.

### BACKGROUND

Telemedicine, also known as telehealth, involves delivery of health-related services and information via telecommunications technologies. A conventional approach is store-and-forward, which does not require the presence of both patient and medical care provider at the same time, such as reviewing data at a time that is convenient for the medical care provider. Another conventional approach is remote monitoring which enables medical professionals to monitor a patient remotely using various technological devices, for managing chronic diseases or specific conditions.

The level of care that is offered to patients via such conventional approaches is very limited, and is inadequate for more complex issues, and a complete and thorough medical exam is impractical.

### SUMMARY

Embodiments disclosed herein provide a telehealth system and process for medical treatment and telemedicine. According to an embodiment, an exemplary telehealth system embodiment may have a telehealth cart including: one or more processors configured to execute computer-executable instructions; a video interface; an audio interface; a vital sign unit; and one or more medical devices connected to the vital sign unit; a patient located proximate to the telehealth cart; a nurse located proximate to the telehealth cart and the patient; a remote physician at a location distal from the patient and the nurse; where the remote physician may establish a secure connection to the telehealth cart and interact with the patient via the video interface and the audio interface of the telehealth cart; and where the nurse may use at least one of the one or more medical devices on the patient at the direction of the remote physician.

In additional system embodiments, the one or more medical devices may include at least one of: a blood pressure monitor, a spirometer, a heart rate monitor, a digital stethoscope, a thermometer, an electrocardiogram (EKG), a glucometer, a dermatoscope, a pulse oximeter, an otoscope, an ophthalmoscope, and a pharyngoscope. The system may also include a secondary cart; where the secondary cart may be connected to the telehealth cart, and where the secondary cart may have one or more high-definition scopes.

In additional system embodiments, the nurse may be a limited vocational nurse (LVN). In additional system embodiments, a data file from the use of the one or more medical devices may be transmitted to the remote physician via the secure connection. In additional system embodiments, at least one of: the data file from the use of the one or more medical devices, an image from the audio interface, and an audio file from the audio interface may be stored by the remote physician in a patient chart. The system may also include a patient chart; where the patient chart may be updated by the remote physician based on a result of the one or more medical devices used on the patient by the nurse.

In additional system embodiments, the remote physician may provide a diagnosis to the patient through the video interface and audio interface of the telehealth cart. In additional system embodiments, the secure connection between the telehealth cart and the remote connection may be ended. In additional system embodiments, the nurse may collect one or more patient samples for testing. In additional system embodiments, the nurse may provide one or more discharge instructions to the patient based on the diagnosis provided to the patient. In additional system embodiments, the nurse may provide one or more treatments to the patient based on the diagnosis provided to the patient. In additional system embodiments, prior to the remote physician establishing a secure connection to the telehealth cart, the nurse may perform one or more medical tests that do not require the presence of the remote physician.

In additional system embodiments, the one or more medical tests that do not require the presence of the remote physician may be at least one of: collecting and documenting the patient vitals, collecting and documenting the patient personal and family history, collecting and documenting the patient medication history, collecting and documenting the patient a chief complaint of the patient, using a blood pressure cuff on the patient, using a thermometer on the patient, using a finger pulse oximeter on the patient, using scale on the patient, and connecting the leads of an electrocardiogram (EKG) to the patient. In additional system embodiments, the system may include a locked storage unit; and one or more medications contained inside the locked storage unit; where the remote physician remotely unlocks the locked storage unit through the secure connection and instructs the nurse to remove one or more of the one or more medications contained inside the storage unit.

In additional system embodiments, the system may include a label printer; where the remote physician may enter medication information, and the medication information may be printed, by the label printer, on a label; and where the remote physician may monitor, via the video interface, the label being placed on a container of the one or more medications by the nurse. In additional system embodiments, the entered medical information printed on the label may be entered into a patient chart.

### BRIEF DESCRIPTION OF THE DRAWINGS

Embodiments of the present invention are illustrated by way of example and not limitation in the figures of the accompanying drawings, which may not be drawn to scale, and in which:

FIG. 1 depicts a technical architecture of an exemplary telehealth system;

FIG. 2 depicts an exemplary telehealth site for treating a patient, running medical tests, and/or dispensing medication;

FIG. 3 depicts an exemplary telehealth cart and secondary cart for connecting a remote physician with a nurse and patient and performing one or more medical tests under the direction of the remote physician;

FIG. 4 depicts an exemplary process of providing medical treatment to a patient via a telehealth system;

FIG. 5 depicts the exemplary process of FIG. 4 involving interaction of a patient, nurse, and remote physician;

FIG. 6 depicts the exemplary process of FIG. 4 involving communication and diagnosis by the remote physician;

FIG. 7 depicts the exemplary process of FIG. 4 involving registration, diagnosis and/or treatment, payment, and additional steps by the patient;

FIG. 8 depicts a high level block diagram of a computing system for implementing an embodiment of a telehealth system and process;

FIG. 9 depicts a comprehensive solution to patient care according to an embodiment of the telehealth system and process;

FIG. 10 depicts example medical treatments suitable for an embodiment of the telehealth system and process, an urgent care center, or an emergency department; and

FIG. 11 depicts a chart of common medical issues in the United States.

### DETAILED DESCRIPTION

The following description is made for the purpose of illustrating the general principles of the embodiments discloses herein and is not meant to limit the concepts disclosed herein. Further, particular features described herein can be used in combination with other described features in each of the various possible combinations and permutations. Unless otherwise specifically defined herein, all terms are to be given their broadest possible interpretation including meanings implied from the description as well as meanings understood by those skilled in the art and/or as defined in dictionaries, treatises, etc.

Embodiments of the telehealth system and process provide improved interactive telehealth solutions in the marketplace, increase public access to immediate care physicians, reduce burdens on emergency rooms, and lower total healthcare costs that an individual, or families, may incur as a result of a strained medical system. There is a shortage of medical physicians, especially for those seeking immediate medical care or urgent care. Embodiments of the telehealth system and process may involve existing physicians at medical clinics, and deploy them in areas where traditional medical services are not provided. Unlike conventional approaches, embodiments of the telehealth system and process disclosed herein enable remote patient visits at or near the same level of care as an actual visit to a physician's office or urgent care. Embodiments of the telehealth system and process provide immediate medical care services by combining on-site nurses, remote contracted physicians, and a full service medical facility in areas where medical access is limited.

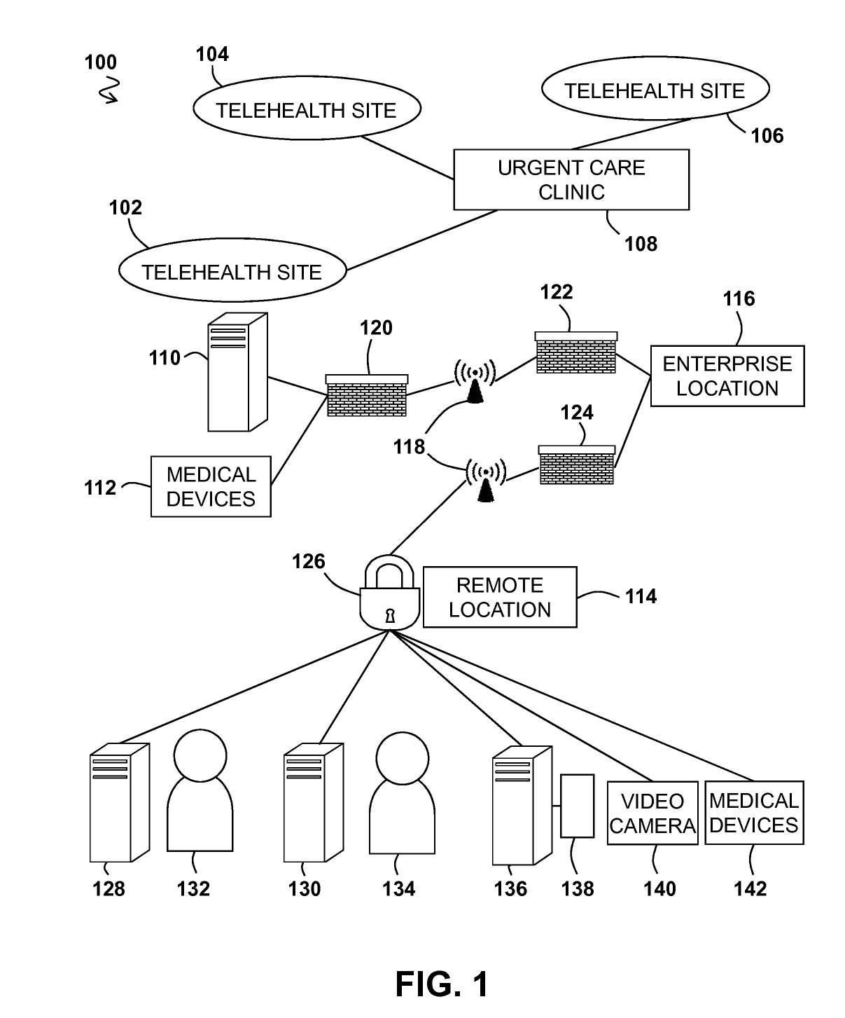

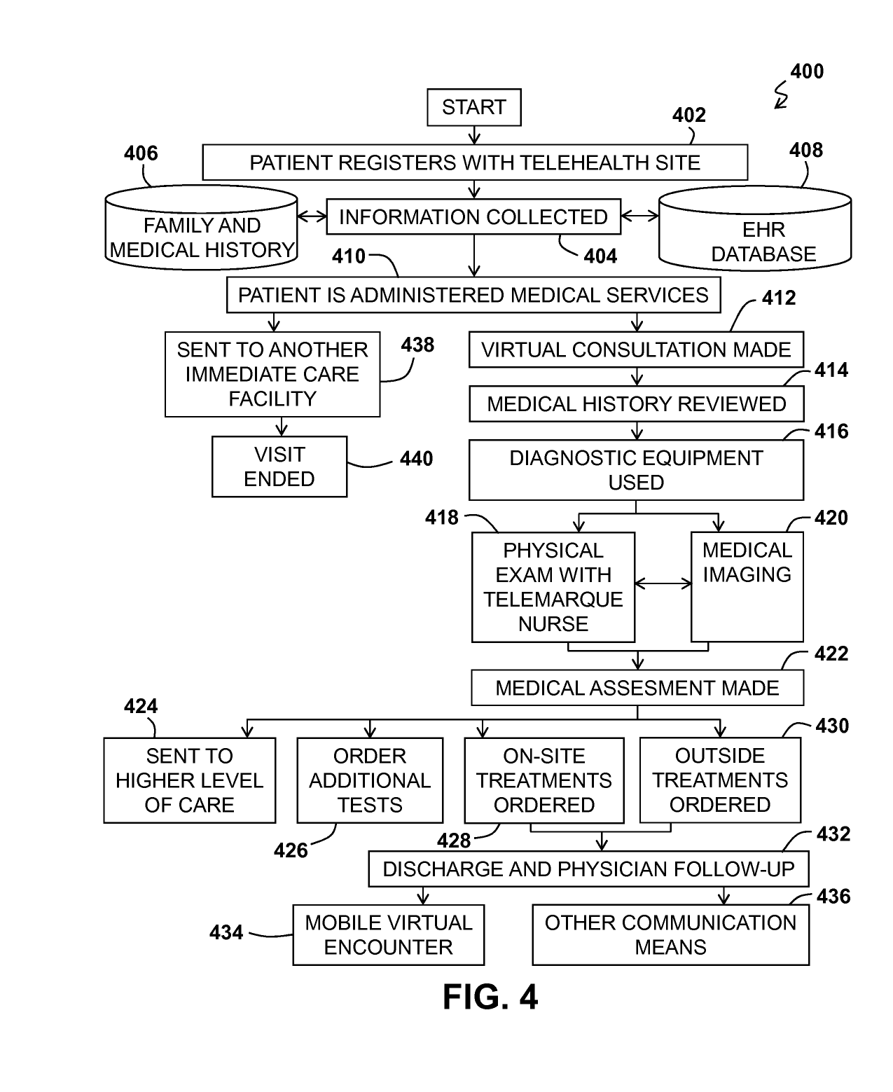

FIG. 1 depicts a technical architecture of an exemplary telehealth system 100. The telehealth system 100 may include one or more telehealth sites (102, 104, 106) where a patient may go to receive medical services. Each telehealth site (102, 104, 106) may be associated with an urgent care clinic 108 for additional medical services. An exemplary telehealth site 102 may include a telehealth cart 110 and one or more medical devices 112 connected to the telehealth cart. The telehealth cart 110 may establish a connection with a remote location 114 through a central enterprise computer in an enterprise location 116. The enterprise location 116 may include a computer system or server including a database, e.g., a cloud platform such as Microsoft Azure. The computer system or server at the enterprise location may perform computing steps, e.g., establishing a secure connection between the telehealth cart 110 and the physician workstation (128,130), and enable remote interaction of the remote physician (132, 134) with the nurse and patient via a videoconferencing platform (See FIG. 4, steps 412, 414, 416, 418, 420, 422, 424, 426, 428, 430, 432). The telehealth cart 110 may establish a connection with the enterprise location 116 via the public internet 118 with secure Health Insurance Portability and Accountability Act (HIPAA) and Confidentiality of Medical Information Act (CMIA) compliant protection measures, e.g., one or more firewalls (120, 122). The enterprise location 116 may be located at a corporate office, urgent care clinic, and/or in the same location as the remote location 114. The enterprise location 116 establishes a connection with a remote location 114 using the same measures of security and encryption, which may include a connection over the public internet 118 and one or more firewalls (124, 126). A virtual private network (VPN) may be established between the remote location 114 and the telehealth site 102. In some embodiments, the remote location 114 may be an urgent care clinic 108.

The remote location 114 may include one or more physician workstations (128, 130) operated by one or more remote physicians (132, 134). The remote physicians (132, 134) may be located at an urgent care site, their homes, or another place of service within the same state. The remote physician (132, 134) is able to view images, audio, and/or data files transmitted from the telehealth cart 110 at the telehealth site 102 behind a secure VPN firewall 126. The remote physician (132, 134) is able to communicate to a patient at the telehealth site (102) via the physician workstation (128, 130), which may transmit images, audio, and/or data files to the telehealth cart 110. The remote physician (132, 134) at the remote location 114 may access the electronic medical records (EMR) 136 of a patient at a telehealth site 102. The remote physician (132, 134) may review and assess a patient via the physician workstation (128, 130), the telehealth cart 110, and one or more medical devices 112 attached to the telehealth cart 110. The telehealth visit session's video conference may not be recorded and/or stored, but images essential to the proper examination of the patient may be stored and made part of the patient's chart, which is accessed through the EMR 136. The EMR 136 may have a backup 138 at the remote location 114. The remote physician (132, 134) may have access to a video camera 140 and/or one or more medical devices 142 used to view and/or listen to the corresponding instruments at the telehealth site 102. For example, the remote physician (132, 134) may use a Bluetooth stereoscope.

Once the patient examination has concluded, the patient is discharged, and the remote connections between all sites (102, 116, 114) are terminated. The patient's record is completed by the remote physician (132, 134). The results and recommendations of the examination are made part of the patient's chart, contained in the EMR 136, for future visits. Patient charts may be electronically sent to a patient's primary medical care provider for additional follow-up. Referrals to outside specialists may be arranged by the remote physician (132, 134). The patient's chart may be reviewed by another specialist at an urgent care clinic 108. Other assessments and treatment options may be recommended via an additional virtual encounter via a home computer or mobile device. Patient discharge instructions may provided to the patient by a nurse at the telehealth site 102.

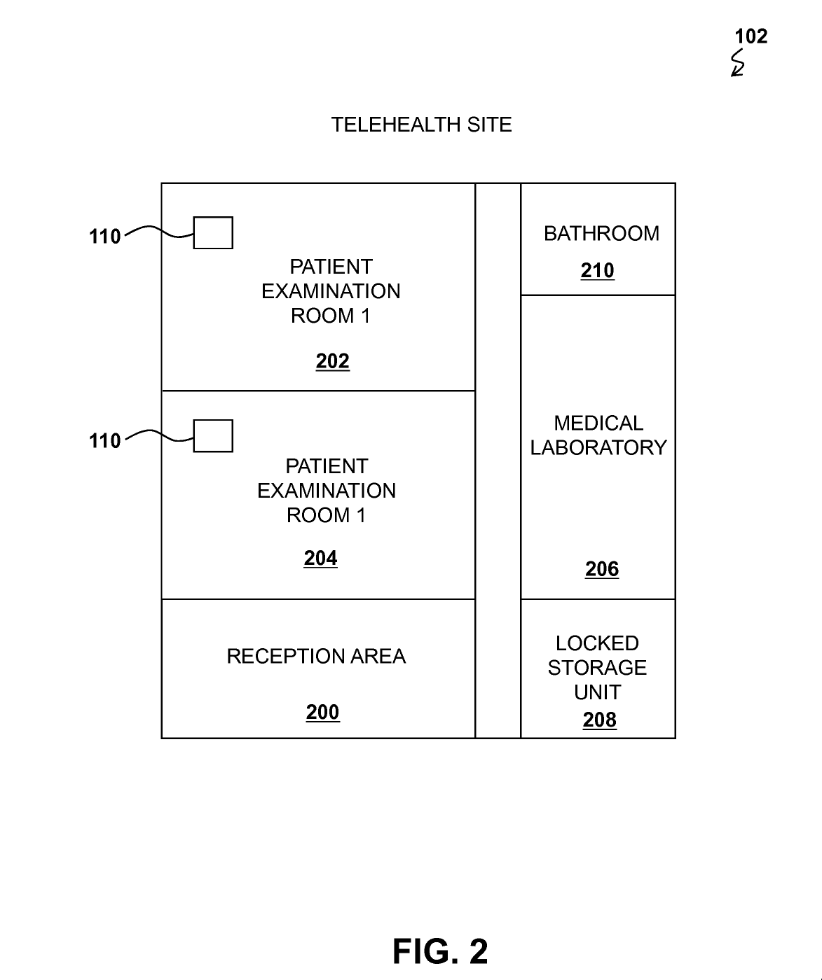

FIG. 2 depicts an exemplary telehealth site 102 for treating a patient, running medical tests, and/or dispensing medication. The telehealth site 102 may be a small medical clinic, e.g., 500-700 square feet, in retail centers, office complexes, apartment building, or other locations where space may limit access to physicians. The telehealth site 102 may include a reception area 200, one or more patient examination rooms (202, 204), a medical laboratory 206 for running on-site medical tests, a locked storage unit for storing and dispensing medicine 208, and a bathroom 210. Each patient exam room (202, 204) may include a telehealth cart 110 to connect a patient and nurse with a remote physician. In a telemedicine visit, the nurse administers the patient visit under the physician guidance, and utilizes peripheral devices, which may include advanced medical equipment, to assist with diagnosis.

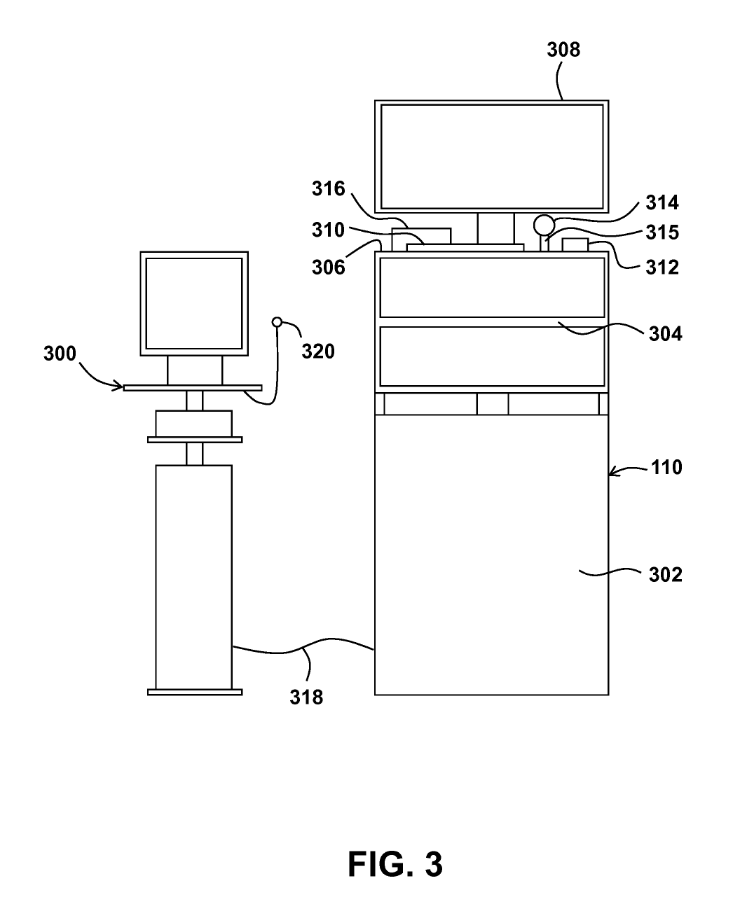

FIG. 3 depicts an exemplary telehealth cart 110 and secondary cart 300 for connecting a remote physician with a nurse and patient and performing one or more medical tests under the direction of the remote physician. Embodiments of the telehealth system and process incorporate all the necessary equipment that a patient would find in a doctor's exam room into one or more carts (110, 300), and allows for a live exchange between the parties, i.e., the nurse, the patient, and the remote physician, via a secure communication link, e.g., the Internet.

In one embodiment, the telehealth cart 110 may be movable and may include a lower cabinet 302 and two drawers 304 for storing one or more medical devices. The telehealth cart 110 may have an eye-level top surface 306 where the videoconferencing devices rest. The video conferencing devices on the telehealth cart 110 may include a computing device having a display 308, an input device such as a keyboard 310 and mouse 312, a camera 314, a microphone 315, and speakers 316. In some embodiments, the computing device may have a touchscreen interface, the monitor 308 may be a high-definition display monitor, and/or the camera 314 may be capable of transmitting high-definition video. The telehealth cart 110 also has an internet connection, e.g., via an Ethernet connection and a 4G wireless backup.

The video conferencing devices may also include a vital sign unit, which connects the one or more medical instruments to the computing device. The vital sign unit is connected to the computing device via a control circuit and a USB to serial TLL interface. The medical devices may be connected to the computing device, e.g., by plugging into a USB port on the computing device. Medical devices that are connected to the vital sign unit send corresponding data to the nurse and remote physician via the telehealth cart 110. The medical devices may include one or more of: a blood pressure monitor, a spirometer, a heart rate monitor, a digital stethoscope, a thermometer, an electrocardiogram (EKG), a glucometer, a dermatoscope, a pulse oximeter, an otoscope, an ophthalmoscope, and a pharyngoscope. The telehealth cart 110 may also include an input cord 318 that connects the telehealth cart 110 to a secondary cart 300. The secondary cart may include additional medical devices, e.g., one or more high-definition scopes 320. Additional medical devices may be connected to the telehealth cart 110 and/or the secondary cart 300.

These medical devices are administered by a nurse, such as a Limited Vocational Nurse (LVN), and allow the remote physician to remotely see and hear the patient via telemedicine video/audio exchanges, as if the remote physician were conducting the exam in person. Many of these medical devices magnify the views and sounds much more than traditional instruments, such as a Bluetooth stethoscope. All telemedicine video, audio, and/or data file exchanges between the patient and the remote physician may be stored on a storage device and made part of that patients chart and may be sent to a patient's primary care provider.

FIG. 4 depicts an exemplary process of providing medical treatment to a patient via a telehealth system 400. In one embodiment, a patient seeking immediate medical care for a non-severe medical issue visits a telehealth site for a virtual telemedicine visit with a remote physician. This allows the patient to receive health care services from a health care provider without in-person contact with the health care provider. At the telehealth site, a nurse and/or front desk receptionist greet the patient and initially assess the reason for the patient visit. The patient is either administered, and registers with the telehealth site (step 402) in accordance with governmental regulations for general authorization for telemedicine, is sent to an urgent care facility, or is sent to another immediate care facility with more capabilities.

Once the patient's need is considered to be appropriate for a virtual telemedicine visit with a remote physician, the patient registers with the telehealth site (step 402). Information is collected on the patient (step 404), which includes collecting patient information on family and medical history 406 and utilizing an electronic health records system (EHR) 406 to store patient medical history and charts. If the patient is a new patient, then the patient may be provided a computer to fill out the patient forms online and document family and medical history 406. The collected information will be shared with the remote physician during the telemedicine visit and made part of the medical chart of the patient, which is stored at a secure remote site (See FIG. 1, 114). If the patient is an existing patient, then the patient signs the required forms as referred to in governmental regulations for general authorization for telemedicine.

Once a nurse is ready to examine the patient, the patient will be guided to a private exam room (See FIG. 2, 202, 204) to be administered medical services (step 410). Additional questions about the patient medical and family history may be asked and documented in the patient's chart in the EHR database, a chief complaint for the patient visit is recorded, and vitals and standard triage treatments may be administered in compliance with governmental regulations for supervision/scope of practice of LVNs, and in accordance with the scope of practice and supervision of licensed vocational nurses using one or more medical devices. Collecting and documenting the patient's vitals, personal and family history, medication history, and chief complaint may be done before the doctor sees the patient. The LVN may perform tests within the scope of practice of an LVN, e.g., using a blood pressure cuff, thermometer, finger pulse oximeter, scale, and connecting the leads of an EKG to a patient. Any additional medical devices are used under the guidance of the remote physician.

Using a remote internet connection, the remote physician reviews the information entered by the nurse, including patient's medical history and chief compliant. After reviewing this information, the remote physician is ready to remotely interact with the patient and the virtual encounter begins through a videoconference platform (step 412). The consultation is conducted by connecting the patient and nurse to the remote physician.

The telehealth cart establishes a secure connection with a remote physician at a remote site. The physician shares his or her understanding of the patient's past medical history, if required, and asks appropriate questions to assist with an accurate diagnosis (step 414).

If required to aid in the proper medical assessment, the remote physician instructs the nurse to administer medical devices (step 416), which includes a number of visual, audio, and diagnostic instruments. The nurse administers the devices (steps 418, 420) in accordance with governmental regulations for supervision/scope of practice of licensed vocational nurses.

Medical images, sounds, and/or data files are reviewed and assessed, and can be made part of the patient's chart. The audio, images, and/or data files of the virtual encounter are viewed by the physician at a remote location behind a secure VPN firewall. The telehealth visit session's video conference may not be recorded or stored in its entirety, but images essential to the proper examination of the patient may be stored and made part of the patient's chart.

After the physician has conducted the examination, a medical assessment is made by the physician (step 422), and courses of treatments are recommended by the physician and made part of the patient's chart (FIG. 1B, Process 7b), which may result in one or more of the following actions. The remote physician may send the patient to a medical facility that can address the issue more appropriately (step 424). The remote physician may instruct the nurse to order one or more on-site tests from a CLIA Waived medical laboratory in accordance with governmental regulations on LVN supervision and scope of practice guidelines for the patient for further diagnosis (step 426). These on-site tests may include a glucose test, rapid flu tests, a cholesterol test, a strep test, a pregnancy test, a urine dip sample, a mono test, tuberculosis (TB) tests, etc. The physician may instruct the nurse to order one or more outside lab tests in accordance with governmental regulations on LVN supervision and scope of practice guidelines (step 426). Ordering one or more outside tests may require the nurse to collect samples from the patient, and store the samples at the on-site medical laboratory until an outside testing courier collects the samples and processes them at the destination laboratory. The physician may prescribe one or more on-site medications (step 428), where medications are stored in a locked storage unit controlled remotely by the remote physician in accordance with governmental regulations on Prescriptions and Medication Dispensing, and dispensed by the nurse accordingly.

The nurse does not have direct access to the locked storage unit containing the medication. The locked storage unit may only be opened via the direct control of the remote physician. The remote physician may remotely unlock, e.g., using an app such as “Lockitron,” the drug cabinet and instruct the nurse to remove the appropriate medication from the locked storage unit and affix a label to a bottle containing the medication. All medication may be contained in tamper-proof bottles with pre-determined quantities of pills.

If the patient wanted the medication to be dispensed at the telehealth site, the remote physician may enter the labeling information and the label may be printed out at the telehealth site. The remote physician may use the same labeling system as currently used by urgent care centers, e.g., by Preferred Pharmaceuticals. Only the remote physician may change the instructions on the label if such a change is needed. Any change made by the remote physician may generate a record in the EMR system. All medications would be made a part of the patient's health record.

In order for the nurse to be able to administer the medication, the remote physician generates the appropriate labeling for the nurse to affix to the container or package. The remote physician is then able to visually observe, e.g., via a two-way video monitor, the nurse putting the labeling on the container or package. The remote physician may then confirm that the labeling and contents of the container or package are correct.

The medications may include basic medications and non-controlled DEA substances, e.g., injectable medications such as: Toradol (60 mg), Phenergan, Benadryl (25 mg), Solu-medrol, Epinephrine, etc. Outside screenings and prescriptions to a pharmacy may be ordered and made part of the patient's chart (step 430). Samples may be collected on-site and sent to an outside medical lab test service. Prescriptions may be electronically prescribed by the physician and sent to any pharmacy within the area.

In one example, lab tests may be ordered via the telemedicine visit, blood may be drawn and sent out to third party vendors, flu shots may be administered, and medicine may be prescribed and even dispensed at the telehealth site. The telehealth system and process may tie a telehealth site to a corresponding urgent care clinic for more advanced testing, such as X-rays, or screenings without having the patient wait for the remote physician or fill out new paperwork.

Once the patient examination has concluded, the patient is discharged (step 432). The remote connection between all sites is terminated. The patient's record is completed by the physician with the results and recommendations of the examination, and made part of the patient's chart for future visits. Charts may be electronically sent to a primary medical care provider for additional follow-up. Referrals to outside specialists may be arranged. The patient's chart may be reviewed by another medical specialist, and other assessments and treatment options may be recommended with an additional virtual encounter via a home computer or mobile device (step 434). In some embodiments, the remote physician and/or medical provider may follow-up with the patient using other communication means (step 436). The follow-up may be conducted by a remote physician. All connections between the remote physician and the patient for a follow-up virtual encounter outside the telehealth site would need to be in a secure and HIPPA-compliant manner. Discharge instructions are provided to the patient by the nurse.

If at any point during the virtual visit it is deemed that the patient has additional conditions that are above the capabilities of a virtual encounter, the patient is sent by the physician to another immediate care facility (step 438), or to an urgent care facility, and the telehealth visit is terminated (step 440).

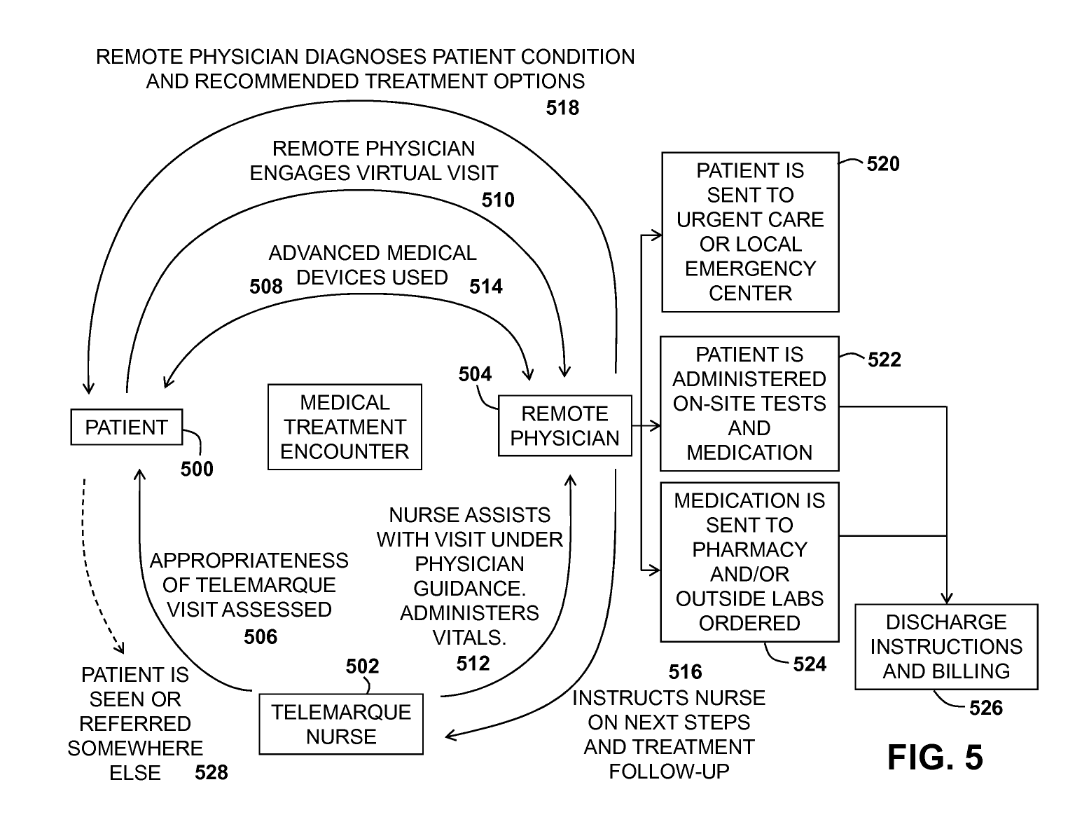

FIG. 5 depicts the exemplary process of FIG. 4 involving interaction of a patient 500, nurse 502, and remote physician 504. The nurse 502 determines the appropriateness of the telehealth visit (step 506). The nurse may use one or more medical devices on the patient (step 508). The remote physician engages the virtual visit with the patient and the nurse (step 510). The nurse assists with the telehealth visit under the guidance of the remote physician, and administers vitals (step 512). The nurse may utilize one or more advanced medical devices under the guidance of the remote physician (step 514). The remote physician instructs the nurse on the next steps and treatment follow-up (step 516). The remote physician diagnoses the patient condition and recommends treatment options (step 518). Based on the diagnosis, the patient may be sent to an urgent care or a local emergency center (step 520); the patient may be administered on-site tests and/or prescribed medication (step 522); or patient medication may be sent to a pharmacy and/or outside lab tests may be ordered (step 524). The patient is discharged and billed for his or her visit (step 526). If the situation requires it, the patient may be seen or referred somewhere else at any stage of the telehealth session (step 528).

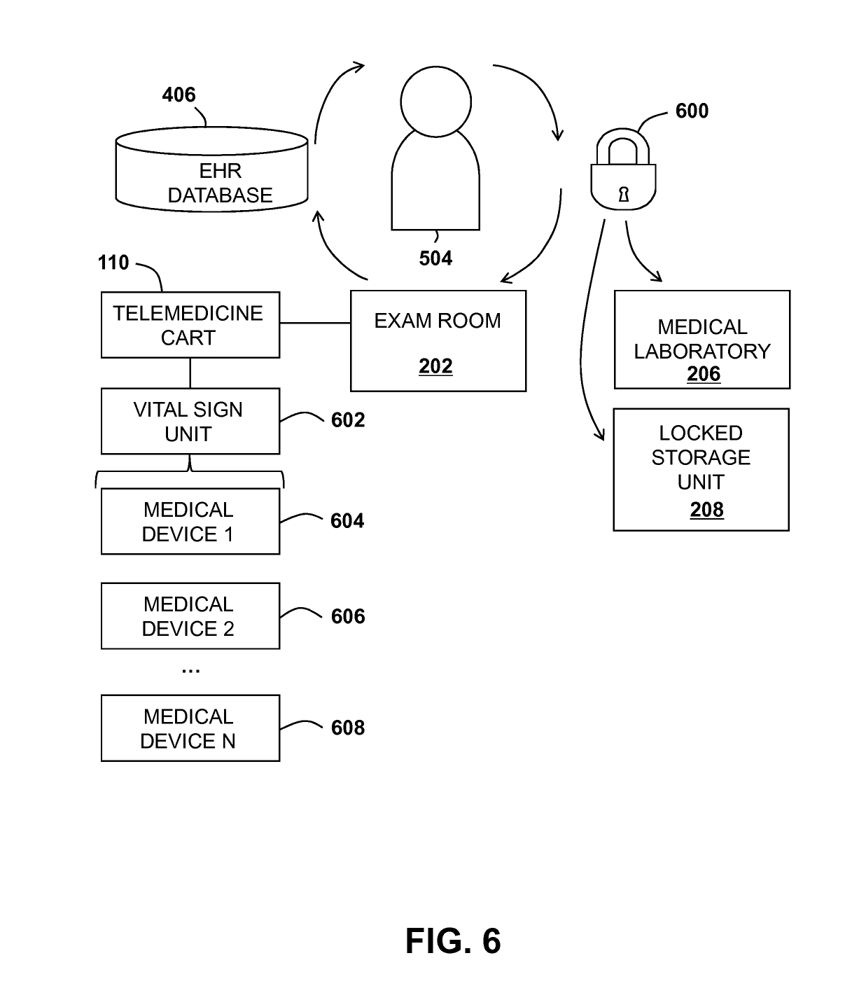

FIG. 6 depicts the exemplary process of FIG. 4 involving communication and diagnosis by the remote physician 504. The remote physician 504 may access the EHR system 406 to retrieve a patient chart. The remote physician 504 may then enter a telehealth session with a patient in the exam room 202 through a secure connection 600. A telehealth cart 110 in the exam room is connected to a vital sign unit 602, which connects one or more medical devices (604, 606, 608) to the telehealth cart 110, which allows the remote physician 504 to securely view any visual, audio, and/or data files from the one or more medical devices (604, 606, 608) as they are administered on a patient by a nurse at the remote physician's 504 direction. The remote physician 504 may then request that additional on-site tests be done in a medical laboratory 206 and/or off-site tests be done, which may require samples be stored in the medical laboratory 206. In some embodiments, the physician may prescribe one or more treatments, which may be stored in a locked storage unit 208, e.g., a room and/or one or more medicine cabinets. The locked storage unit 208 may be controlled by the remote physician 504 via the secure connection 600.

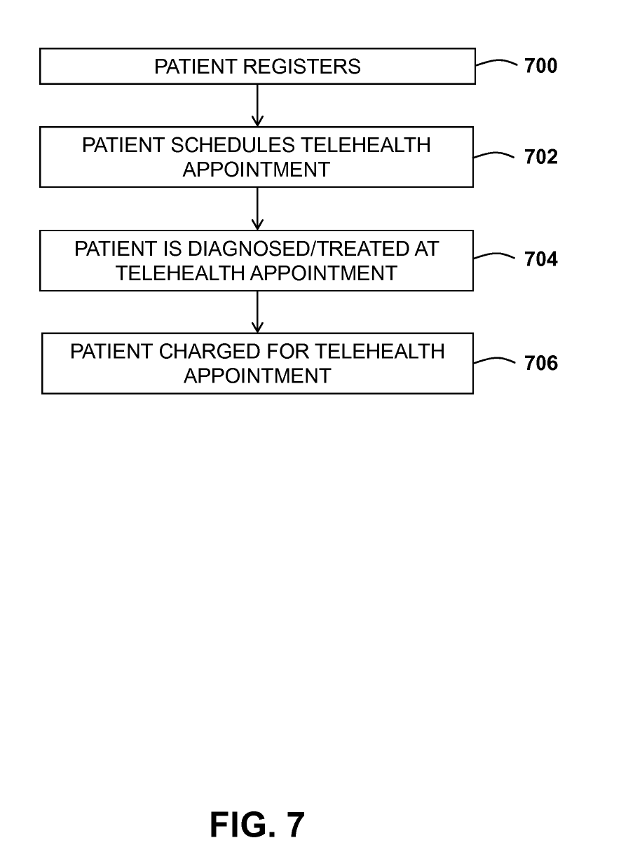

FIG. 7 depicts the exemplary process of FIG. 4 involving registration, diagnosis and/or treatment, payment, and additional steps by the patient. The patient registers for access to the telehealth site (step 700). The patient schedules a telehealth appointment (step 702). The telehealth appointment may be scheduled online, which is particularly useful for busy professionals who have tight schedules, and a desire to wait at their workplace versus a waiting room. The patient is diagnosed and/or treated at the telehealth appointment (step 704). The patient is charged for the telehealth appointment (step 706).

The patient cost of the telehealth appointment may based on a tiered pricing schedule. For example, a first tier may cover a chief complaint and assessment; a second tier may cover a chief complaint and associated symptoms, where additional testing may be required; a third tier may cover more complex diagnosis, and additional on-site and off-site testing may be required. There may be additional charges for the cost of medicines, lab handling fees, and other charges related to the telehealth visit.

A telehealth visit may or may not be a covered benefit under many insurance plans. As such, the telehealth visit fees may be collected up front and billed to insurance as a courtesy to the patient. If the patient's insurance pays for the visit, the telehealth site will reimburse the patient up to the amount of the office visit fee. Once payment is made, either by cash, check, credit card, debit card, or a health savings account card, the patient will receive a copy of the bill along with the physician discharge instructions.

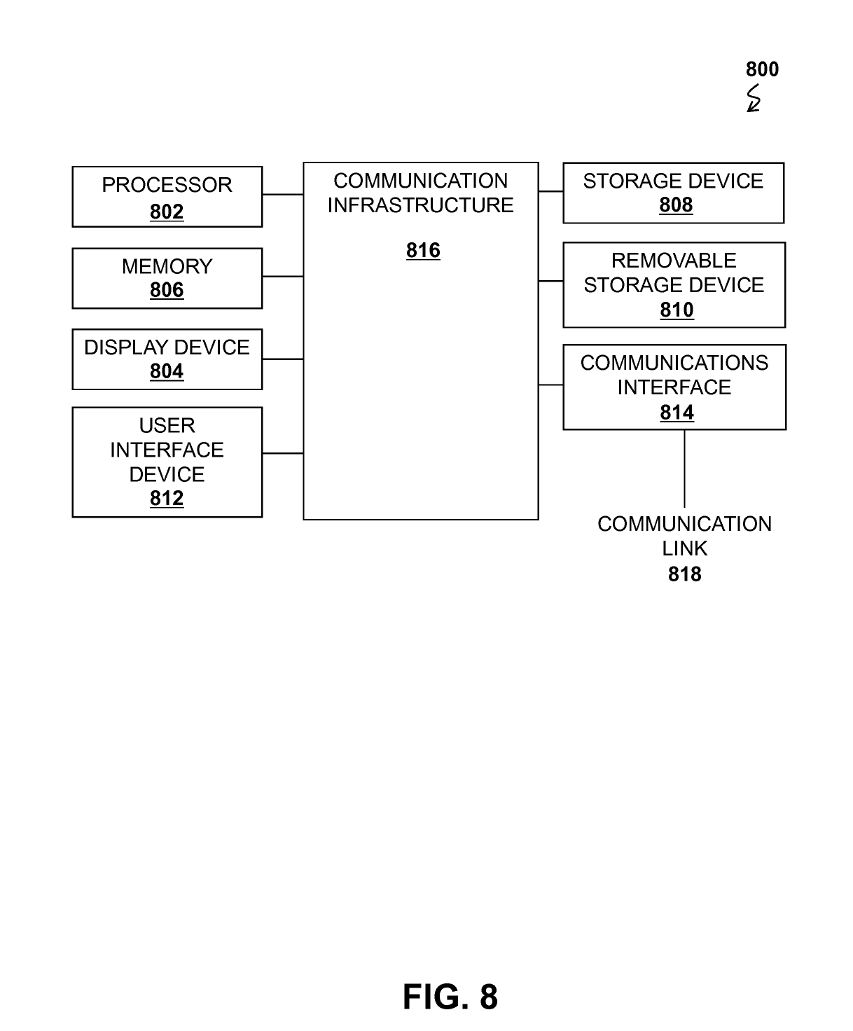

FIG. 8 depicts a high level block diagram of a computing system for implementing an embodiment of a telehealth system and process 800. The computer system includes one or more processors 802; an electronic display device for displaying graphics, text, and other data 804; a main memory 806, e.g., random access memory (RAM); a storage device 808; a removable storage device 810, e.g., a removable storage drive, removable memory module, a magnetic tape drive, optical disk drive, computer readable medium having stored therein computer software and/or data; a user interface device 812, e.g., keyboard, touch screen, keypad, pointing device; and a communication interface 814, e.g., modem, a network interface, such as an Ethernet card, a communications port, and/or a PCMCIA slot and card. The communication interface allows software and data to be transferred between the computer system and external devices. The system further includes a communications infrastructure 816, e.g., a communications bus, cross-over bar, or network, to which the aforementioned devices/modules are connected as shown.

Information transferred via the communications interface may be in the form of signals such as electronic, electromagnetic, optical, or other signals capable of being received by the communications interface, via a communication link 818 that carries signals and may be implemented using wire or cable, fiber optics, a phone line, a cellular/mobile phone link, a radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

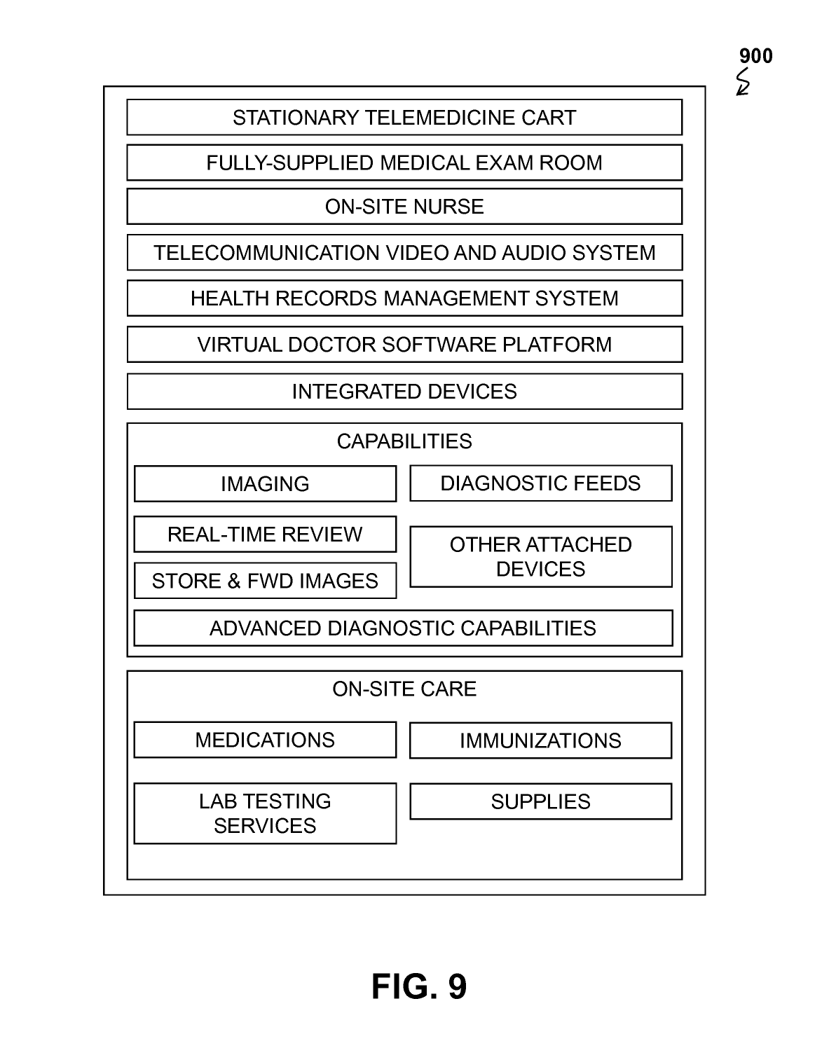

FIG. 9 depicts a comprehensive solution to patient care according to an embodiment of the telehealth system and process 900. The telehealth system and process disclosed herein provides improvements over the conventional solutions by enhancing the level of care. According to an embodiment, the telehealth system and process disclosed herein is dynamic, providing immediate services during the consultation such as medications, vaccinations, or hands-on medical support by an on-site nurse, etc. Further, according to an embodiment of the telehealth system and process disclosed herein, telemedicine visits in the immediate care area involve physicians for the consultations.

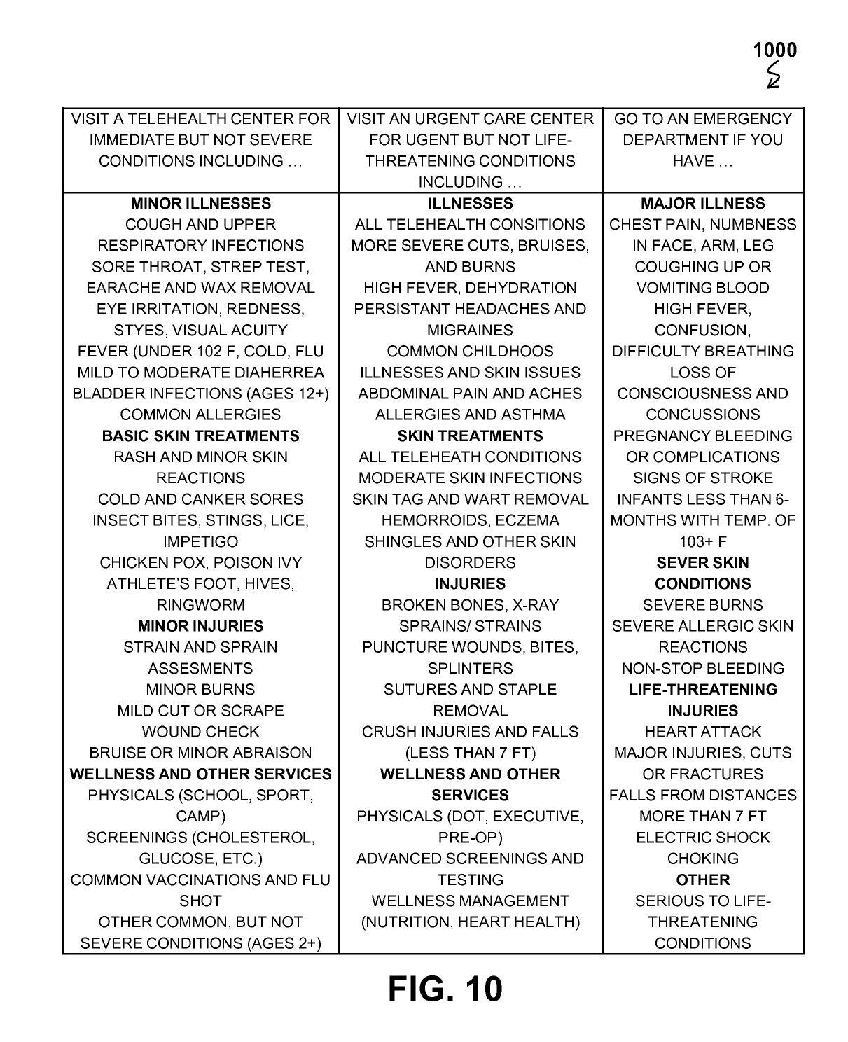

FIG. 10 depicts example medical treatments suitable for an embodiment of the telehealth system and process, an urgent care center, or an emergency department 1000. For example, a telehealth site may be suitable for treating minor illnesses, basic skin treatments, minor injuries, and wellness and other services. An urgent care center may be suitable for all of the conditions of a telehealth site, plus skin treatments, injuries, and additional wellness and other services. An emergency department may be suitable for major illnesses, severe skin conditions, life-threatening injuries, and serious to life-threatening conditions.

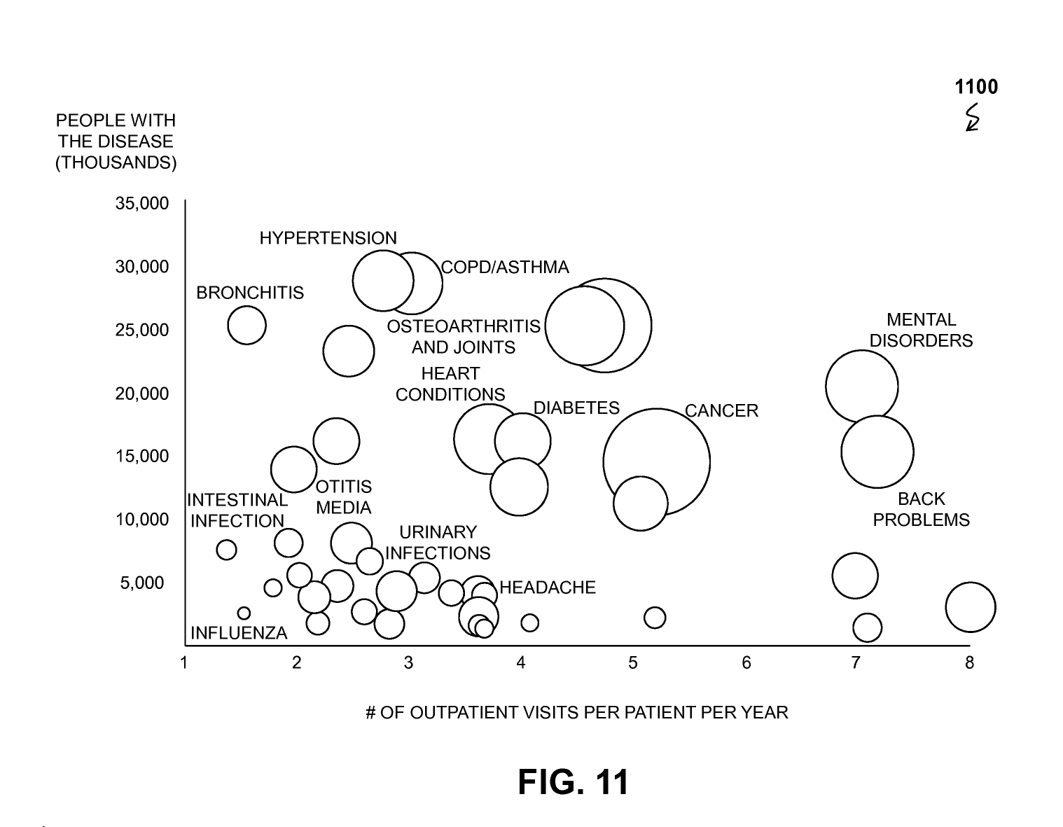

FIG. 11 depicts a chart of common medical issues in the United States according to Agency for Healthcare Research and Quality (source AHRQUS Outpatient Spend 2011) 1100. In one example, about 85% of clinic visits for such common medical issues may be initially treated by the telehealth system and process disclosed herein.

Embodiments of the telehealth system and process provide access to immediate care physicians while achieving a lower cost of healthcare, e.g., a patient visit may range from $59 to $99, and a claim may be submitted to a patient's insurance for reimbursement if necessary. This is a lower amount than a typical primary care office visit, e.g., costing over $150, an urgent care visit, e.g., costing around $130, and a visit to an emergency room (ER), e.g., over $500. Up to 85% of the patient visits and from 30% to 70% of ER visits may be handled by using the telehealth system and process disclosed herein. The telehealth system and process helps keep communities healthy and protected against common diseases by providing convenient access to on-site medicines, vaccinations, and immunizations. Patients are provided the treatment they need without visits to a pharmacy or to their primary care provider. The most common vaccinations and immunizations, e.g., for flu shots, Tdap vaccines, Hepatitis, etc., may be stocked at the telehealth site. Patients that may have otherwise not opted for these important wellness services will benefit from the telehealth system and process. The telehealth system and process allows for better patient care and more accurate diagnoses, because advanced diagnostic tools are available that are administered by a nurse at the patient location. The telehealth system and process also creates a higher level of care availability as sites may be available for extended hours, e.g., 7 days a week, from 7 am to 10 pm on most days. There are very few immediate care alternatives available during these early morning or late evening hours, making an expensive ER visit the only available choice. The telehealth system and process affords access to immediate care physicians. Telehealth sites may be placed in areas where access may typically be very difficult, e.g., busy office complexes, small retail spaces, crowded apartment communities, or rural areas where physicians will not locate to.

Embodiments of the telehealth system and process include a computer implemented business model which involves approval and cooperation of many medical oversight organizations and compliance parties, based on legal compliance criteria according to governmental regulations on telemedicine and related regulations. Embodiments of the telehealth system involve providing telemedicine using technology combined with human or add-on elements, such as on-site nurses and medical supplies, by combining technological solutions with physical locations where that technology is deployed.

Embodiments of the telehealth system and process deliver a comprehensive medical solution utilizing multiple tools and processes to deliver a timely, meaningful experience for each patient visit. The tools utilized may include one or more of the following tools. Communication tools may include standard and enhanced video, secure text chat, secure asynchronous messaging, and ‘multiple party’ functions within the video consult. Branding tools may include strefront logos and images, and a dedicated web address sub-domain. Provider tools may include a telehealth virtual doctor cart with associated medical devices attached, online waiting and exam rooms, e-Prescribing, integrated practice staff support roles, warm transfer between providers, provider to provider consultations, and follow-up tools such as sick slips and referrals. Content tools may include patient health assessments, including health history intake. System access tools may include system-generated patient invitations, a bulk import of a patient panel, and direct access through a subdomain URL. Health data tools may include the EMR and self-reported patient health record, and an online consultation data export using standard formats. Financial processing tools may include standard credit card processing, and pricing at the practice or provider level. Training and marketing tools may include the training of employers or businesses via Web-ex, a marketing plan and template materials, and telemedicine best practices. Reporting tools may include practice reports to employers and progress reports for Worker Comp claims. Customer support tools may include an existing network of telehealth employees and a call center.

According to an embodiment of the telehealth system and process, a professional medical corporation may be created (“Clinic Company”). In one example, the professional medical corporation may be at least partly owned by a physician. Subject to the availability of insurance coverage and applicable deductibles and copayments, the Clinic Company bills the patient and/or the patient's insurance carrier for said telehealth services. In one implementation, the Clinic Company would subcontract with an entity to provide physician services to the patients of the Clinic Company. In another example, the Clinic Company may directly hire its own dedicated physicians.

The Clinic Company may be managed by a new management services organization (“MSO”) that would provide the Clinic Company, on a turnkey basis, with office space, tenant improvements, furniture, fixtures, and equipment, non-prescription medical supplies, and management and administrative services. The MSO may charge the Clinic Company a fee based upon a percentage of the Clinic Company gross collections. The MSO may be owned by interested and qualified investors. The Clinic Company and physician owner would be tied to the MSO through a series of agreements including a management services agreement, security agreement and an assignable stock option agreement.

The related patient charges are deposited into the Clinic Company bank account, and made available to the operation. The Clinic Company may then pay contracted physicians and company employees their required wages. The operation may also pay the MSO their required management fee that covers non-physician Clinic Company staff, expenses related to the patient visit, and operational overhead for the management services. The embodiments of the telehealth system and process disclosed herein are in compliance with the governmental regulations on telemedicine and related medical practices while providing the benefits disclosed herein.

Embodiments have been described with reference to flowchart illustrations and/or block diagrams of methods, apparatus (systems) and computer program products according to embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing embodiments. In alternative implementations, the functions noted in the blocks may occur out of the order noted in the figures, concurrently, etc.

Computer programs, i.e., computer control logic, are stored in main memory and/or secondary memory. Computer programs may also be received via a communications interface. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system.

Though embodiments have been described with reference to certain versions thereof; however, other versions are possible. Therefore, the spirit and scope of the embodiments should not be limited to the description of the preferred versions contained herein.

What is claimed is:

1. A system comprising:
a telehealth cart comprising:
one or more processors configured to execute computer-executable instructions;
a video interface;
an audio interface;
a vital sign unit; and
one or more medical devices connected to the vital sign unit;
wherein the system enables a remote physician, at a location remote from a patient and a nurse located proximate to the telehealth cart, to interact with the patient;
wherein the system enables the remote physician to establish a secure connection to the telehealth cart and interact with the patient via the video interface and the audio interface of the telehealth cart; and
wherein the system enables the nurse to apply at least one of the one or more medical devices to the patient at the direction of the remote physician.

2. The system of claim 1 wherein the one or more medical devices includes at least one of: a blood pressure monitor, a spirometer, a heart rate monitor, a digital stethoscope, a thermometer, an electrocardiogram (EKG), a glucometer, a dermatoscope, a pulse oximeter, an otoscope, an ophthalmoscope, and a pharyngoscope.

3. The system of claim 1 further comprising:
a secondary cart;
wherein the secondary cart is connected to the telehealth cart, and wherein the secondary cart comprises one or more high-definition scopes.

4. The system of claim 1 wherein the nurse is a limited vocational nurse (LVN).

5. The system of claim 1 wherein a data file from the application of the one or more medical devices to the patient is transmitted to the remote physician via the secure connection.

6. The system of claim 5 wherein at least one of: the data file from the application of the one or more medical devices, an image from the video interface, and an audio file from the audio interface is stored by the remote physician in a patient chart.

7. The system of claim 1 further comprising:
a module for maintaining a patient chart;
wherein the patient chart is updated by the remote physician based on a result of the one or more medical devices application on the patient by the nurse.

8. The system of claim 1 wherein the remote physician provides a diagnosis to the patient through the video interface and audio interface of the telehealth cart.

9. The system of claim 8 wherein the secure connection between the telehealth cart and the remote connection is ended after the remote physician provides the diagnosis to the patient.

10. The system of claim 8 wherein the telecart enables the nurse to collect one or more patient samples for testing.

11. The system of claim 8 wherein the system enables the nurse to provide one or more discharge instructions to the patient based on the diagnosis provided to the patient by the remote physician.

12. The system of claim 8 wherein the system enables the nurse to provide one or more treatments to the patient based on the diagnosis provided to the patient by the remote physician.

13. The system of claim 1 wherein, prior to the remote physician establishing a secure connection to the telehealth cart, the system enables the nurse to perform one or more medical tests that do not require the presence of the remote physician.

14. The system of claim 13 wherein the one or more medical tests that do not require the presence of the remote physician are at least one of: collecting and documenting the patient vitals, collecting and documenting the patient personal and family history, collecting and documenting the patient medication history, collecting and documenting the patient a chief complaint of the patient, using a blood pressure cuff on the patient, using a thermometer on the patient, using a finger pulse oximeter on the patient, using scale on the patient, and connecting the leads of an electrocardiogram (EKG) to the patient.

15. The system of claim 1 further comprising:
a locked storage unit; and
one or more medications contained inside the locked storage unit;
wherein the system enables the remote physician remotely unlock the locked storage unit through the secure connection and dispense one or more medications contained inside the storage unit to the patient based on said diagnosis.

16. The system of claim 15 further comprising:
a label printer;
wherein the system enables the remote physician to enter medication information, and the medication information is printed, by the label printer, on a label; and
wherein the system enables the remote physician to monitor, via the video interface, the label being placed on a container of the one or more medications by the nurse.

17. The system of claim 16 wherein the system enables the entered medical information printed on the label to be entered into a patient chart.
